(19) United States
(12) Patent Application Publication
(10) Pub. No.: US 2012/0263996 A1
(43) Pub. Date: Oct. 18, 2012

(54) ELECTROCHEMICAL CELL

(75) Inventors: HYUN-KI PARK, Yongin-si (KR); Dong-Hee Han, Yongin-si (KR)

(73) Assignee: Samsung SDI Co., Ltd., Yongin-si (KR)

(21) Appl. No.: 13/244,179

(22) Filed: Sep. 23, 2011

(30) Foreign Application Priority Data
Apr. 15, 2011 (KR) 10- 2011-0035156

(51) Int. Cl. H01M 6/42; H01M 10/02

(52) U.S. Cl. 429/149

(57) ABSTRACT

An electrochemical cell is disclosed. In one embodiment, the cell includes i) a housing comprising first, second and third chambers, wherein the first chamber is interposed between the second and third chambers, ii) a first separator spatially separating the first and second chambers and iii) a second separator spatially separating the first and third chambers.

### RELATED APPLICATIONS

This application claims the benefit of Korean Patent Application No. 10-2011-0035156, filed on Apr. 15, 2011, in the Korean Intellectual Property Office, the disclosure of which is incorporated herein in its entirety by reference.

### BACKGROUND

1. Field

The described technology generally relates to electrochemical cells.

2. Description of the Related Technology

Research has been conducted on sodium-based electrochemical cells for storing electric power generated from various sources. Examples of those power sources include solar power and wind power. Also, the stored electricity can be used across a wide spectrum of residential and commercial applications such as household use and electric vehicles.

Sodium-based electrochemical cells are a large capacity cell which can store power of several kW to MW and have a high energy density and a long lifespan, and thus may be used in various fields.

### SUMMARY

One inventive aspect is electrochemical cells including a double separator consisting of a first separator and a second separator.

Another aspect is an electrochemical cell that includes: a housing including a first chamber and a second chamber and a third chamber that are disposed opposite to each other while having the first chamber interposed therebetween; a first separator spatially separating the first chamber and the second chamber; and a second separator spatially separating the first chamber and the third chamber.

The second chamber and the third chamber may have the same polarity, and the first chamber may have a different polarity from that of the second chamber and the third chamber.

The second chamber and the third chamber may include positive electrode chambers, and the first chamber may include a negative electrode chamber.

The electrochemical cell may further include a negative electrode collector included inside the first chamber.

The second chamber and the third chamber may include negative electrode chambers, and the first chamber may include a positive electrode chamber.

The electrochemical cell may further include a negative electrode collector included in at least one selected from the group consisting of the second chamber and the third chamber.

The second separator may be disposed in the first separator.

The second chamber may be disposed outside the first separator, and the first chamber may be disposed between the first separator and the second separator, and the third chamber may be included inside the second separator.

The first separator and the second separator may have a hollow tube shape.

The first separator and the second separator may have a cross-section that is one selected from the group consisting of a circle, an oval, or a polygon.

A plurality of second separators may be separated from one another inside the first separator.

Another aspect is an electrochemical cell that includes: a housing including a first chamber and a second chamber and a third chamber that are disposed opposite to each other while having the first chamber interposed therebetween; a first separator spatially separating the first chamber and the second chamber and including a first surface exposed toward the first chamber and a second surface exposed toward the second chamber; and a second separator spatially separating the first chamber and the third chamber and including a third surface exposed toward the first chamber and a fourth surface exposed toward the third chamber, wherein the first chamber has a different polarity from that of the second chamber and the third chamber.

The first chamber may include a negative electrode chamber, and the second chamber and the third chamber may include positive electrode chambers.

The electrochemical cell may further include a negative electrode collector included in the first chamber.

The negative electrode collector may be disposed adjacent to the first surface of the first separator and the third surface of the second separator.

The first chamber may include a positive electrode chamber, and the second chamber and the third chamber may include negative electrode chambers.

The electrochemical cell may further include a negative electrode collector included in at least one selected from the group consisting of the second chamber and the third chamber.

The electrochemical cell may further include a negative electrode collector that is disposed adjacent to at least one selected from the group consisting of the second surface of the first separator and the fourth surface of the second separator.

The second separator may be disposed inside the first separator.

The second chamber may be disposed outside the first separator, and the first chamber may be disposed between the first separator and the second separator, and the third chamber may be included inside the second separator.

The first separator and the second separator may have a hollow tube shape.

The first separator and the second separator may have a cross-section that is one selected from the group consisting of a circle, an oval, or a polygon.

A plurality of second separators may be separated from one another inside the first separator. Another aspect is an electrochemical cell comprising: a housing comprising first, second and third chambers, wherein the first chamber is interposed between the second and third chambers; a first separator spatially separating the first and second chambers; and a second separator spatially separating the first and third chambers.

In the above electrochemical cell, the second and third chambers have the same polarity, and wherein the first chamber has a different polarity from that of the second and third chambers. In the above electrochemical cell, each of the second and third chambers has a positive polarity, and wherein the first chamber has a negative polarity. In the above electrochemical cell, the first chamber contains a negative electrode collector therein. In the above electrochemical cell, each of the second and third chambers has a negative polarity, and wherein the first chamber has a positive polarity. In the above electrochemical cell, at least one of the second and third chambers contains a negative electrode collector therein.

In the above electrochemical cell, the second separator is substantially enclosed by the first separator. In the above electrochemical cell, the second chamber substantially encloses the first separator, wherein the first chamber is interposed between the first and second separators, and wherein the third chamber is substantially enclosed by the second separator. In the above electrochemical cell, each of the first and second separators has a hollow tube shape. In the above electrochemical cell, each of the first and second separators has one of the following cross-sections: a circle, an oval and a polygon. The above electrochemical cell further comprises a plurality of second separators which are separated from one another and substantially enclosed by the first separator.

Another aspect is an electrochemical cell comprising: a housing comprising first, second and third chambers, wherein the first chamber is interposed between the second and third chambers, wherein the first chamber has inner and outer boundaries, wherein the second chamber has an inner boundary, and wherein the third chamber has an outer boundary; a first separator spatially separating the first and second chambers, wherein the first separator has a first surface forming the outer boundary of the first chamber and a second surface forming the inner boundary of the second chamber; and a second separator spatially separating the first and third chambers, wherein the second separator has a third surface forming the inner boundary of the first chamber and a fourth surface forming the outer boundary of the third chamber, wherein the first chamber has a different polarity from that of the second and third chambers.

The above electrochemical cell further comprises a negative electrode collector a majority portion of which is located inside the first chamber. In the above electrochemical cell, the negative electrode collector is located adjacent to the first surface of the first separator and the third surface of the second separator. In the above electrochemical cell, at least one of the second and third chambers contains a negative electrode collector therein. The above electrochemical cell further comprises a negative electrode collector that is located adjacent to at least one of: i) the second surface of the first separator and ii) the fourth surface of the second separator.

In the above electrochemical cell, the second separator is substantially enclosed by the first separator. In the above electrochemical cell, the second chamber substantially encloses the first separator, wherein the first chamber is interposed between the first and second separators, and wherein the third chamber is substantially enclosed by the second separator. The above electrochemical cell further comprises a plurality of second separators which are separated from one another and substantially enclosed by the first separator.

Another aspect is an electrochemical cell comprising: a housing comprising (N+2) chambers, wherein N is a natural number, wherein two adjacent chambers have different polarities, and wherein each of the chambers contains one of a positive electrode material and a negative electrode material; and (N+1) separators each of which physically separates the chambers.

### BRIEF DESCRIPTION OF THE DRAWINGS

FIG. 1 is a longitudinal cross-sectional view illustrating a tube-type electrochemical cell according to an embodiment.

FIG. 2 is a cross-sectional view of the electrochemical cell of FIG. 1 cut along a line II-II.

FIG. 3 is a cross-sectional view illustrating an electrochemical cell according to another embodiment.

FIG. 4 is a longitudinal cross-sectional illustrating a tube-type electrochemical cell according to another embodiment.

FIG. 5 is a cross-sectional view of the electrochemical cell of FIG. 4 cut along a line V-V;

FIG. 6 is a cross-sectional view illustrating an electrochemical cell according to another embodiment.

FIGS. 7A through 7D are cross-sectional views illustrating an electrochemical cell, in which a housing, a first separator, and a second separator are selectively illustrated.

FIG. 8 is a cross-sectional view illustrating planar-type electrochemical cell according to another embodiment.

FIG. 9 is a graph showing energy storage capacity of an electrochemical cell according to the number of times of charging and discharging.

### DETAILED DESCRIPTION

Embodiments will be described with reference to the accompanying drawings. These embodiments are not considered limiting and may be modified in various ways.

Throughout the specification, a singular form may include plural forms, unless there is a particular description contrary thereto. While such terms as “first,” “second,” etc., may be used to describe various components, such components must not be limited to the above terms. The above terms are used only to distinguish one component from another.

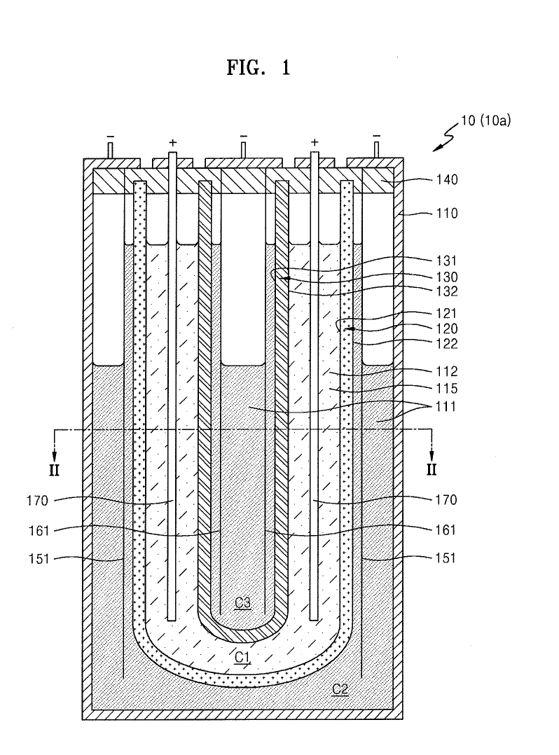

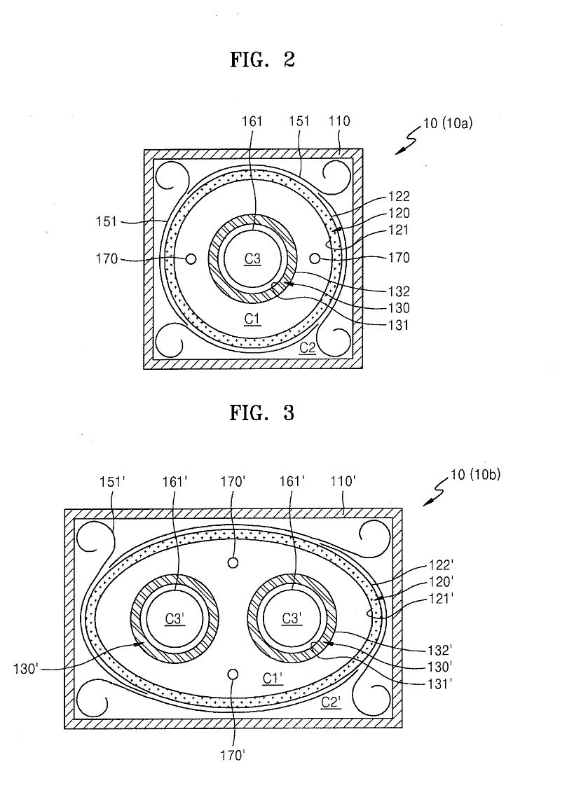

FIG. 1 is a longitudinal cross-sectional view illustrating a tube-type electrochemical cell 10a according to an embodiment. FIG. 2 is a cross-sectional view of the electrochemical cell of FIG. 1 cut along a line II-II.

Referring to FIGS. 1 and 2, the electrochemical cell 10a includes a housing 110, and a first separator 120 and a second separator 130 located inside the housing 110. The first separator 120 divides an inner space of the housing 110 into a first chamber C1 and a second chamber C2, and the second separator 130 divides an inner space of the housing 110 into the first chamber C1 and a third chamber C3.

The housing 110 may have an approximately hexahedron-shape extending in a longitudinal direction. However, the housing 110 may have other polygonal or semi-circular shape. The housing 110 may include a side wall extended in the longitudinal direction and a lower wall and an upper wall that are substantially perpendicularly curved with respect to the sidewall. The size and shape of the housing 110 may be various. The housing 110 may include a metallic material such as stainless steel (SUS). The housing 110 may contain i) more than three chambers, for example, (N+2) chambers and ii) more than two separators, for example, (N+1) separators each of which physically separates the chambers, wherein N is a natural number. In this embodiment, two adjacent chambers have different polarities, and each of the chambers contains one of a positive electrode material and a negative electrode material.

The first separator 120 is located inside the housing 110 to spatially separate the first chamber C1 and the second chamber C2 from each other. The inner surface 121 of the first separator 120 is exposed toward or forms an outer boundary of the first chamber C1, and the outer surface 122 of the first separator 120 is exposed toward or forms an inner boundary of the second chamber C2. In one embodiment, the first separator 120 has a tube shape extending in the longitudinal direction, and an upper portion of which is opened; a lower surface of the first separator 120 is separated from an inner surface of a lower portion of the housing 110 by a predetermined distance.

The second separator 130 is located inside or substantially enclosed by the first separator 120 to spatially separate the first chamber C1 and the third chamber C3 from each other. The inner surface 131 of the second separator 130 is exposed toward or forms an outer boundary of the third chamber C3, and the outer surface 132 of the second separator 130 is exposed toward or forms an inner boundary of the first chamber C1. In one embodiment, the second separator 130 has a tube shape extending in the longitudinal direction, and an upper portion of which is opened; and a lower surface of the second separator 130 is separated from an inner surface 121 of a lower portion of the first separator 120 by a predetermined distance. The opened upper portion of the first separator 120 and the opened upper portion of the second separator 130 may be coupled to an insulator 140.

In one embodiment, the first and second separators 120 and 130 are in the form of a tube having a circular cross-section; an outer diameter of the second separator 130 is smaller than an inner diameter of the first separator 120. In this embodiment, the first and second separators 120 and 130 are in a substantially concentric form from the housing 110 toward a central axis (see FIG. 2).

In one embodiment, the first and second separators 120 and 130 allow ions of a Group 1 metal to flow therethrough. For example, each of the separators 120 and 130 may include β-alumina or β″-alumina which have a good ionic conductivity or a mixture of these. Alternatively, each of the first and second separators 120 and 130 may include a zeolite, a feldspar, or a sodium-ion-conductive glass.

The insulator 140 seals the opened upper portions of the first and second separators 120 and 130, and electrically insulates the first chamber C1, the second chamber C2, and the third chamber C3 from one another. The first and second separators 120 and 130 may be coupled to the insulator 140 using an adhesive material such as glass frit. For example, a-alumina may be used as the insulator 140.

The first chamber C1 has a different polarity from those of the second chamber C2 or the third chamber C3, and may be a positive electrode chamber, and the second chamber C2 and the third chamber C3 may have the same polarity and may be negative electrode chambers.

In one embodiment, as negative electrode chambers, each of the second and third chambers C2 and C3 includes a negative electrode material 111. Group 1 metal such as sodium may be used as a negative electrode material 111. For example, sodium is molten and thus exists as a liquid phase. In addition to sodium, the negative electrode material 111 may be other Group 1 metals such as lithium, potassium, or a mixture including these metals and sodium.

A first negative electrode collector 151 includes a conductive material such as nickel or SUS to provide a moving path of electrons during charging or discharging the electrochemical cell 10a. Here, the housing 110 may also function as a negative electrode collector.

Meanwhile, the first negative electrode collector 151 may be disposed adjacent to the outer surface 122 of the first separator 120 within the second chamber C2. In one embodiment, in order to induce capillary phenomenon, a narrow gap is formed between the first negative electrode collector 151 and the outer surface 122 of the first separator 120. Accordingly, even if the second chamber C2 is not fully filled with the negative electrode material 111 (e.g. sodium), the negative electrode material 111 may be contained between the outer surface 122 of the first separator 120 and the first negative electrode collector 151 and may be involved in reactions based on charging and discharging.

In one embodiment, like the first negative electrode collector 151, the second negative electrode collector 161 also includes a conductive material such as nickel or SUS to provide a moving path of electrons during charging or discharging the electrochemical cell 10a.

Meanwhile, a second negative electrode collector 161 may be disposed adjacent to the inner surface 131 of the second separator 130 within the third chamber C3. In one embodiment, in order to induce capillary phenomenon, a narrow gap is formed between the second negative electrode collector 161 and the inner surface 131 of the second separator 130. Accordingly, even if the third chamber C3 is not fully filled with the negative electrode material 111 (e.g. sodium), the negative electrode material 111 may be contained between the inner surface 131 of the second separator 130 and the second negative electrode collector 161 and may be involved in reactions based on charging or discharging.

Referring to FIG. 2, a plurality of the first negative electrode collectors 151 may be included and may be disposed adjacent to the outer surface 122 of the first separator 120. The second negative electrode collector 161 may be a single unit type, and may be disposed adjacent to the inner surface 131 of the second separator 130.

In one embodiment, a plurality of the first negative electrode collectors 151 are disposed adjacent to the outer surface 122 of the first separator 120, and one second negative electrode collector 161 is disposed adjacent to the inner surface 131 of the second separator 130. However, one first negative electrode collector 151 may be disposed adjacent to the outer surface 122 of the first separator 120, and a plurality of second negative electrode collectors 161 may be disposed adjacent to the inner surface 131 of the second separator 130.

In one embodiment, the first and second negative electrode collectors 151 and 161 provide a moving path for electrons and induce capillary action at the same time. However, the first and second negative electrode collectors 151 and 161 may function only as a negative electrode collector providing a moving path for electrons, and capillary phenomenon may be induced by further including an additional member (not shown).

As a positive electrode chamber, the first chamber C1 includes a positive electrode material 112. The positive electrode material 112 may have electric conductivity and porosity. The positive electrode material 112 may be formed of a transition metal including nickel, cobalt, zinc, chromium, iron, etc. In a charging state, the positive electrode material 112 forms TCl₂. Here, Cl refers to a chloride of a liquid electrolyte 115, and T refers to a transition metal.

The first chamber C1 may include a liquid electrolyte 115. The liquid electrolyte 115 may exist in an impregnated in a positive electrode material having electric conductivity and porosity. For example, sodium tetrachloro aluminate (NaAlCl₄) may be used as the liquid electrolyte. NaAlCl₄ may be formed of a compound of sodium chloride (NaCl) and aluminum chloride (AlCl₃), which are substantially equimolar. The liquid electrolyte 115 is in a molten state at the operating temperature of the electrochemical cell 10a.

A positive electrode collector 170 may be extended within the chamber C1 in the longitudinal direction. The positive electrode collector 170 may include a metallic material such as nickel. The positive electrode collector 170 may be in the form of a pole, as shown in FIG. 2, or may be cylindrical, latticed, etc. In one embodiment, two positive electrode collectors 170 are included in the first chamber C1. However, depending on the embodiment, a single positive electrode collector or more than two positive electrode collectors may be provided in the first chamber C1.

In one embodiment, the electrochemical cell 10a is used for a rechargeable battery, a charging/discharging formula of which is as follows. In the formula, it is assumed that a positive electrode material is nickel (Ni), and a negative electrode material is sodium (Na).

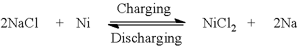

During discharging, sodium ions and electrons are generated in the second chamber C2 which is a negative electrode chamber, and the sodium ions move via the first separator 120 to the first chamber C1 which is a positive electrode chamber. The sodium ions that have moved react with a positive electrode material and electrons in the first chamber C1. Likewise, sodium ions and electrons are generated in the third chamber C3 which is a negative electrode chamber, and the generated sodium ions move from the third chamber C3 to the first chamber C1 via the second separator 130 and then react with a positive electrode material and electrons in the first chamber C1.

The charging reaction is an inverse version of the discharging reaction. During charging, sodium ions are generated in the first chamber C1 which is a positive electrode chamber. Some of the generated sodium ions move to the second chamber C2 via the first separator 120, and the rest move to the third chamber C3 via the second separator 130. The sodium ions that have moved react with electrons in the second chamber C2 and the third chamber C3.

The total surface area of the first and second separators 120 and 130 of the electrochemical cell 10a is significantly increased compared to an electrochemical cell having a single separator. That is, since an area where sodium and the first and second separators 120 and 130 directly contact each other is increased, output density of the electrochemical cell 10a is increased. Also, due to an increase of the path via which sodium ions generated during charging or discharging may move, the sodium ions may take part in charging or discharging reactions more actively, thereby increasing an energy storage density of the electrochemical cell 10a.

Also, due to the double separator structure of the first and second separators 120 and 130, charging or discharging is performed i) between the first and second chambers C1 and C2, and ii) between the first and third chambers C1 and C3 substantially at the same time. Thus, compared to an electrochemical cell including only one separator, energy density and output density of the electrochemical cell 10a is significantly increased. For example, the electrochemical cell 10a has an energy density of about 130 Wh/kg and an output density of about 150 W/kg to about 200 W/kg, which are significantly greater than those of a single-separator electrochemical cell.

FIG. 3 is a cross-sectional view illustrating an electrochemical cell 10b according to another embodiment.

Referring to FIG. 3, the electrochemical 10b is different from the electrochemical cell 10a shown in FIGS. 1 and 2 in that a plurality of second separators 130′ are located inside or substantially enclosed by the first separator 120′. In the FIG. 3 embodiment, the number of negative electrode chambers C3′ is further increased, in which charging and discharging may be generated. Thus, energy density and output density of the electrochemical cell 10b may be further increased.

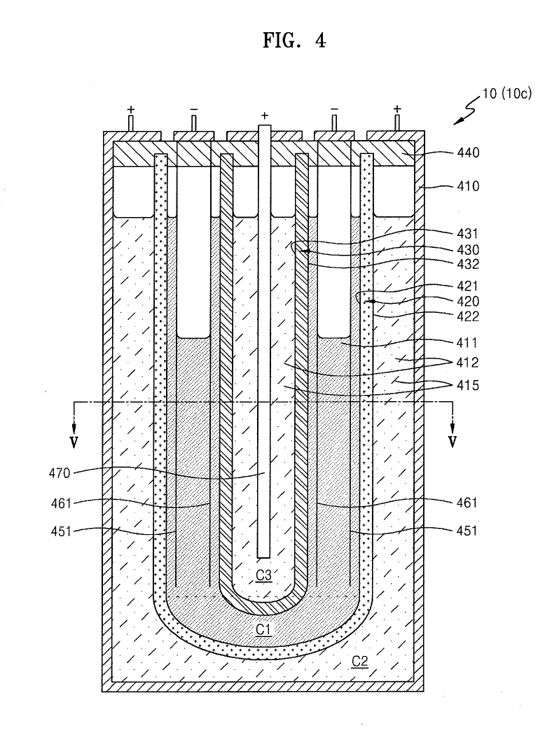

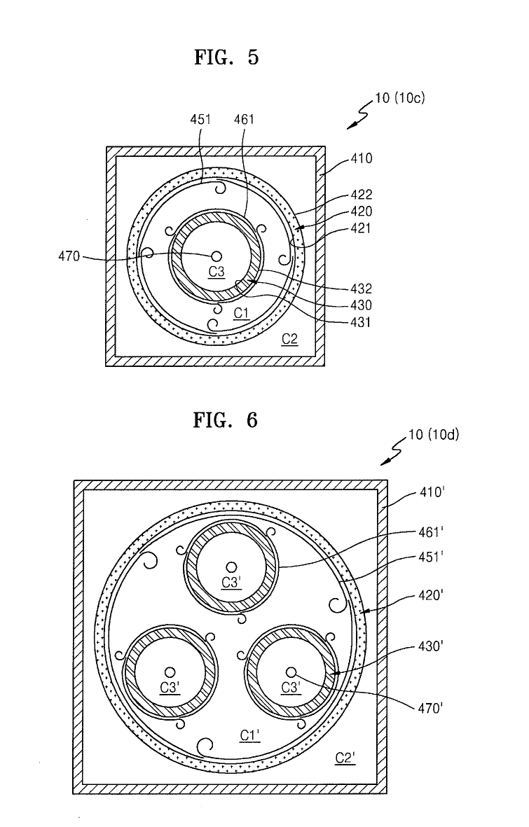

FIG. 4 is a longitudinal cross-sectional illustrating a tube-type electrochemical cell 10c according to another embodiment. FIG. 5 is a cross-sectional view of the electrochemical cell 10c of FIG. 1 cut along a line V-V of FIG. 4.

Referring to FIGS. 4 and 5, the electrochemical cell 10c includes a housing 410 and a first separator 420 included in the housing 410, and a second separator 430 located inside the first separator 420. A first chamber C1 and a second chamber C2 are spatially separated by the first separator 420, and the first chamber C1 and a third chamber C3 are spatially separated by the second separator 430 as in the electrochemical cell 10a described with reference to FIGS. 1 and 2.

The electrochemical cell 10c is different from the electrochemical cell 10a of FIGS. 1 and 2 in that the first chamber C1 is a negative electrode chamber, and the second chamber C2 and the third chamber C3 are positive electrode chambers.

The first chamber C1 is a negative electrode chamber including a negative electrode material 411. As described above, the negative electrode material 411 may include a Group 1 metal such as sodium.

A plurality of first negative electrode collectors 451 and a plurality of second negative electrode collectors 461 are located inside the first chamber C1. The first and second negative electrode collectors 451 and 452 include a conductive material to provide a moving path of electrons during charging and discharging of the electrochemical cell 10c.

Meanwhile, the first negative electrode collectors 451 may be disposed adjacent to the inner surface 421 of the first separator 420, and the second negative electrode collectors 461 may be disposed adjacent to the outer surface 432 of the second separator 430. In one embodiment, in order to induce capillary phenomenon, the first negative electrode collectors 451 are disposed such that a narrow gap is formed between the first negative electrode collectors 451 and the inner surface 421 of the first separator 420. Accordingly, even if the first chamber C1 is not fully filled with the negative electrode material 411 (e.g. sodium), the negative electrode material 411 may efficiently take part in charging and discharging. To induce capillary phenomenon, the second negative electrode collectors 461 may also be disposed such that a narrow gap is formed between the second negative electrode collectors 461 and the outer surface 432 of the second separator 430.

In the current embodiment, the first and second negative electrode collectors 451 and 461 provide a moving path for electrons and induce capillary phenomenon substantially at the same time. However, the negative electrode collectors 451 and 461 may function only as a negative electrode collector providing a moving path for electrons, and capillary phenomenon may be induced by further including an additional member (not shown).

In the current embodiment, the negative electrode collectors 451 are disposed on the inner surface 421 of the first separator 420, and the second negative electrode collectors 461 are disposed on the outer surface 432 of the second separator 430. However, one first negative electrode collector 451 may be disposed on the inner surface 421 of the first separator 420, and one second negative electrode collector 461 may be disposed on the outer surface 431 of the second separator 430.

In one embodiment, as positive electrode chambers, each of the second and third chambers C2 and C3 contains a positive electrode material 412. As described above, the positive electrode material 412 may have electric conductivity and porosity. The positive electrode material 412 may be formed of a transition metal including nickel, cobalt, zinc, chromium, iron, etc.

Also, each of the second and third chambers C2 and C3 may include a liquid electrolyte 415 such as sodium tetrachloro aluminate (NaAlCl₄). The liquid electrolyte may be impregnated in the positive electrode material 412 having porosity.

The positive electrode collector 470 may extend in the third chamber C3 in the longitudinal direction. The positive electrode collector 470 may include a metallic material such as nickel. In the second chamber C2 which is another positive electrode chamber, the housing 410 may perform the function of the positive electrode collector 470. In this case, the housing 410 may include a material having electric conductivity.

Compared to an electrochemical cell having a single separator, the total surface area of the separators 420 and 430 is significantly increased. Thus, as an area where sodium and the two separators 420 and 430 directly contact is increased, output density of the electrochemical cell 10c is increased. In addition, due to an increase of the path via which the generated sodium ions may move during charging or discharging, the sodium ions may actively participate in the charging and discharging reactions, thereby increasing energy density of the electrochemical cell 10c.

Also, due to the double-separator structure consisting of the first and second separators 420 and 430, charging or discharging is performed i) between the first and second chambers C1 and C2, and ii) between the first and third chambers C1 and C3 substantially at the same time. Thus, compared to an electrochemical cell having a single separator, energy density and output density of the electrochemical cell 10c according to the current embodiment is significantly increased.

FIG. 6 is a cross-sectional view illustrating an electrochemical cell 10d according to another embodiment.

Referring to FIG. 6, the electrochemical cell 10d is different from the electrochemical cell 10c of FIGS. 4 and 5 in that a plurality of second separators 430′ are located inside the first separator 420′. In the current embodiment in which a plurality of second separators 430′ are included, the number of positive electrode chambers is further increased, in which charging and discharging can be generated. Thus, energy density and output density may be further increased.

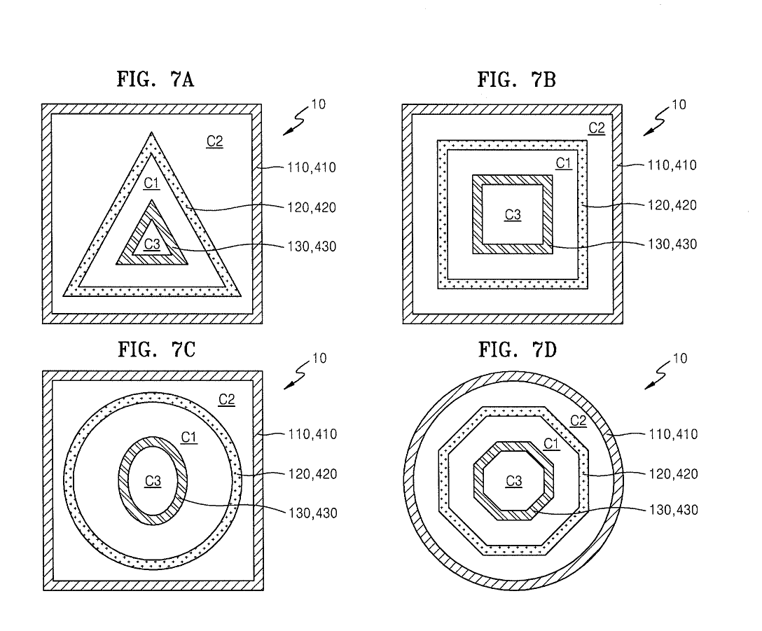

FIGS. 7A through 7D are cross-sectional views illustrating the electrochemical cell 10 according to embodiments, in which the housing 110 and 410, the first separator 120 and 420, and the second separator 130 and 430 are selectively illustrated.

Referring to FIGS. 7A through 7D, the first separator 120 and 420 and the second separator 130 and 430 may have a triangular, quadrilateral, or hexagonal cross-section. Alternatively, the first separator 120 and 420 and the second separator 130 and 430 may have cross-sections of other various shapes.

Meanwhile, the shapes of the first separator 120 and 420 and the second separator 130 and 430 may not be similar. For example, the first separator 120 and 420 may have a circular cross-section, and the second separator 130 and 430 may have an oval cross-section.

The housing 110 and 410 may also have a cross-section of various shapes such as a quadrangle, a circle, or an oval.

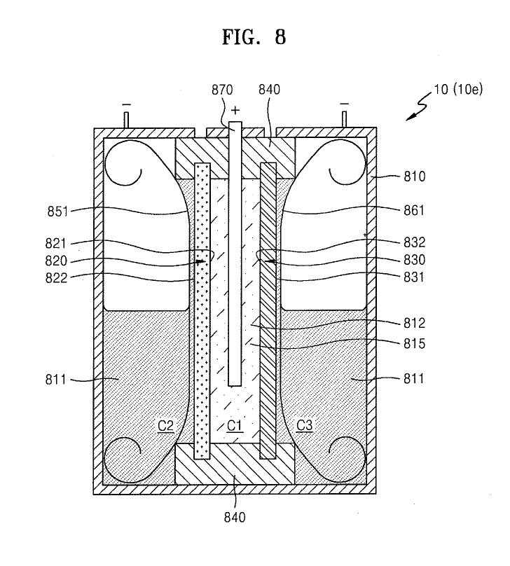

FIG. 8 is a cross-sectional view illustrating a planar-type electrochemical cell 10e according to another embodiment. While the electrochemical cell 10 described with reference to FIGS. 1 through 7 is a tube-type extending in the longitudinal direction, the electrochemical cell 10e according to the current embodiment is substantially planar.

Referring to FIG. 8, the electrochemical cell 10e includes a housing 810, and a first separator 820 and a second separator 830 included in the housing 810. The first separator 820 divides an inner space of the housing 810 into a first chamber C1 and a second chamber C2, and the second separator 830 divides an inner space of the housing 810 into the first chamber C1 and a third chamber C3.

The housing 810 may have an approximately hexahedron-shape. The housing 810 may be formed of a metallic material such as SUS. In one embodiment, the housing 810 is illustrated as a single unit in the current embodiment. However, the housing 810 may be divided into a left housing (not shown) and a right housing (not shown) facing each other around an insulator 840.

In one embodiment, the first separator 820 is substantially planar. The first separator 820 is located inside the housing 810 to spatially separate the first chamber C1 and the second chamber C2 from each other. A first surface 821 of the first separator 820 is exposed toward the first chamber C1, and a second surface 822 of the first separator 820 is exposed toward the second chamber C2.

In one embodiment, the second separator 830 is substantially planar and is disposed separately from the first separator 820 by a predetermined distance. The second separator 830 is located inside the housing 810 and spatially separates the first chamber C1 and the third chamber C3. A first surface 832 of the second separator 830 is exposed toward the first chamber C1, and a second surface 831 of the second separator 830 is exposed toward the third chamber C3.

In one embodiment, each of the first and second separators 820 and 830 has ionic conductivity of a Group 1 metal. For example, each of the separators 820 and 830 may include β-alumina or β″-alumina which have a good ionic conductivity or a mixture of these. Alternatively, each of the separators 820 and 830 may include a zeolite, a feldspar, or a sodium-ion-conductive glass.

Two ends of the first and second separators 820 and 830 may be coupled to the insulator 840. For example, the two separators 820 and 830 may be coupled to the insulator 840 using an adhesive material such as glass frit. The insulator 840 fixes the first and second separators 820 and 830 such that the separators 820 and 830 are separated from each other by a predetermined distance, and electrically insulates the first to third chambers C1-C3 from one another. For example, a-alumina may be used as the insulator 840.

The first chamber C1 may have a different polarity from that of the second chamber C2 or the third chamber C3, and the second chamber C2 and the third chamber C3 may have the same polarity.

In one embodiment, as negative electrode chambers, each of the two chambers C2 and C3 includes a negative electrode material 811. Group 1 metal such as sodium may be used as a negative electrode material 811. For example, sodium is molten and thus exists as a liquid phrase. In addition to sodium, the negative electrode material 811 may be other Group 1 metals such as lithium, potassium, or a mixture including these metals and sodium.

In one embodiment, a first negative electrode collector 851 includes a conductive material such as SUS. The housing 810 may also function as a negative electrode collector.

Meanwhile, the first negative electrode collector 851 may be disposed adjacent to the second surface 822 of the first separator 820 in the second chamber C2. Then, in this case, in order to induce capillary phenomenon, a narrow gap may be formed between the first negative electrode collector 851 and the second surface 822 of the first separator 820. Accordingly, even if the second chamber C2 is not fully filled with the negative electrode material 811 (e.g. sodium), the negative electrode material 811 may be contained between the first separator 820 and the first negative electrode collector 851 and may be involved in reactions based on charging or discharging.

The second negative electrode collector 861 may also include a material such as SUS. Also, the housing 810 may function as a negative electrode collector.

Meanwhile, a second negative electrode collector 861 may be disposed adjacent to the second surface 831 of the second separator 830 in the third chamber C3. In this case, a narrow gap may be formed between the second negative electrode collector 861 and the second surface 831 of the second separator 830 to induce capillary phenomenon. Due to the capillary phenomenon, the negative material 811 may be contained between the second separator 830 and the second negative electrode collector 861 and may be involved in reactions of charging or discharging.

As a positive electrode chamber, the first chamber C1 includes a positive electrode material 812. The positive electrode material 812 may have electric conductivity and porosity. The positive electrode material 812 may be formed of a transition metal including nickel, cobalt, zinc, chromium, iron, etc. In a charging state, the positive electrode material 812 forms TCl₂. Here, Cl refers to a chloride of a liquid electrolyte 815, and T refers to a transition metal.

The first chamber C1 may include a liquid electrolyte 815. The liquid electrolyte 815 may exist in an impregnated in the positive electrode material 812 having electric conductivity and porosity. For example, sodium tetrachloro aluminate (NaAlCl₄) may be used as the liquid electrolyte 815. The liquid electrolyte 815 exists in a molten state at the operating temperature of the electrochemical cell 10e.

A positive electrode collector 870 is located inside the first chamber C1, and facilitates movement of electrons which participate in charging or discharging reactions in the first chamber C1.

As the electrochemical cell 10e of the current embodiment also includes a double separator including the first separator 820 and a second separator 830, the total surface area of the first and second separators 820 and 830 is significantly increased, and charging or discharging is conducted between the first chamber C1 and the second chamber C2 and between the first chamber C1 and the third chamber C3 at the same time. Thus, an area where sodium and the first and second separators 820 and 830 may directly contact is increased, and thus output density of the electrochemical cell 10e is increased. In addition, energy density of the electrochemical cell 10e is increased.

The energy density and output density of the electrochemical cell 10e may be further increased compared to an electrochemical cell which has the same size but has a single separator.

According to the current embodiment, the first chamber C1 is a positive electrode chamber, and the second and third chambers C2 and C3 are negative electrode chambers. However, the first chamber C1 may be a negative electrode chamber, and the second and third chambers C2 and C3 are positive electrode chambers. In this case, the first and second negative electrode collectors 851 and 861 are within the first chamber C1. For example, the first negative electrode collector 851 may be disposed adjacent to the first separator 820 in the first chamber C1, and the second negative electrode collector 861 may be disposed adjacent to the second separator 830 in the first chamber C1. Meanwhile, the housing 810 may function as a positive electrode collector.

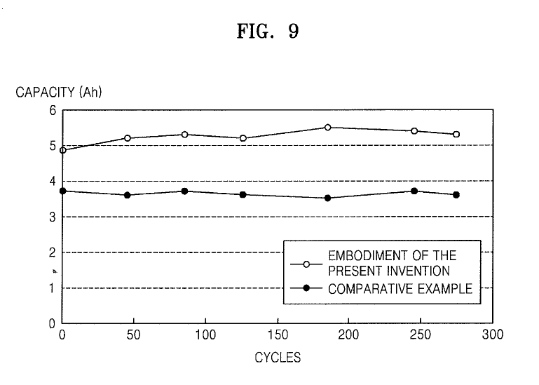

FIG. 9 is a graph showing energy storage capacity of the electrochemical cell 10a of an inventive embodiment and an electrochemical cell of a comparative example according to cycles of charging and discharging. The electrochemical cell 10a refers to that described with reference to FIGS. 1 and 2, and the electrochemical cell of the comparative example includes only one separator.

Referring to FIG. 9, during charging and discharging, a capacity of the electrochemical cell 10 is about 5 Ah or more, but that of the electrochemical cell of the comparative example is only about 3.8 Ah. As described in the graph, the energy storage capacity of the electrochemical cell 10a is significantly increased compared to the electrochemical cell of the comparative example.

In at least one of the above embodiments, the electrochemical cell 10 includes a transition metal such as nickel as a positive electrode material and sodium tetrachloro aluminate (NaAlCl₄) as a liquid electrolyte. However, a sodium-sulfur (NaS) based cell, which includes sulfur as a positive electrode material, may also be used.

According to at least one of the disclosed embodiments, by including a double-separator in an electrochemical cell based on a Group 1 metal such as sodium, energy density and output density of the electrochemical cell is substantially enhanced.

It should be understood that the disclosed embodiments should be considered in a descriptive sense only and not for purposes of limitation. Descriptions of features or aspects within each embodiment should typically be considered as available for other similar features or aspects in other embodiments.

What is claimed is:

1. An electrochemical cell comprising:
a housing comprising first, second and third chambers, wherein the first chamber is interposed between the second and third chambers;
a first separator spatially separating the first and second chambers; and
a second separator spatially separating the first and third chambers.

2. The electrochemical cell of claim 1, wherein the second and third chambers have the same polarity, and wherein the first chamber has a different polarity from that of the second and third chambers.

3. The electrochemical cell of claim 2, wherein each of the second and third chambers has a positive polarity, and wherein the first chamber has a negative polarity.

4. The electrochemical cell of claim 3, wherein the first chamber contains a negative electrode collector therein.

5. The electrochemical cell of claim 2, wherein each of the second and third chambers has a negative polarity, and wherein the first chamber has a positive polarity.

6. The electrochemical cell of claim 5, wherein at least one of the second and third chambers contains a negative electrode collector therein.

7. The electrochemical cell of claim 5, wherein the second separator is substantially enclosed by the first separator.

8. The electrochemical cell of claim 7, wherein the second chamber substantially encloses the first separator, wherein the first chamber is interposed between the first and second separators, and wherein the third chamber is substantially enclosed by the second separator.

9. The electrochemical cell of claim 7, wherein each of the first and second separators has a hollow tube shape.

10. The electrochemical cell of claim 7, wherein each of the first and second separators has one of the following cross-sections: a circle, an oval and a polygon.

11. The electrochemical cell of claim 7, further comprising a plurality of second separators which are separated from one another and substantially enclosed by the first separator.

12. An electrochemical cell comprising:
a housing comprising first, second and third chambers, wherein the first chamber is interposed between the second and third chambers, wherein the first chamber has inner and outer boundaries, wherein the second chamber has an inner boundary, and wherein the third chamber has an outer boundary; a first separator spatially separating the first and second chambers, wherein the first separator has a first surface forming the outer boundary of the first chamber and a second surface forming the inner boundary of the second chamber; and
a second separator spatially separating the first and third chambers, wherein the second separator has a third surface forming the inner boundary of the first chamber and a fourth surface forming the outer boundary of the third chamber,
wherein the first chamber has a different polarity from that of the second and third chambers.

13. The electrochemical cell of claim 12, further comprising a negative electrode collector a majority portion of which is located inside the first chamber.

14. The electrochemical cell of claim 13, wherein the negative electrode collector is located adjacent to the first surface of the first separator and the third surface of the second separator.

15. The electrochemical cell of claim 12, wherein at least one of the second and third chambers contains a negative electrode collector therein.

16. The electrochemical cell of claim 15, further comprising a negative electrode collector that is located adjacent to at least one of: i) the second surface of the first separator and ii) the fourth surface of the second separator.

17. The electrochemical cell of claim 12, wherein the second separator is substantially enclosed by the first separator.

18. The electrochemical cell of claim 17, wherein the second chamber substantially encloses the first separator, wherein the first chamber is interposed between the first and second separators, and wherein the third chamber is substantially enclosed by the second separator.

19. The electrochemical cell of claim 17, further comprising a plurality of second separators which are separated from one another and substantially enclosed by the first separator.

20. An electrochemical cell comprising:
a housing comprising (N+2) chambers, wherein N is a natural number, wherein two adjacent chambers have different polarities, and wherein each of the chambers contains one of a positive electrode material and a negative electrode material; and
(N+1) separators each of which physically separates the chambers.
